(19) United States
(12) Patent Application Publication
(10) Pub. No.: US 2013/0162426 A1
(43) Pub. Date: Jun. 27, 2013

(54) Wireless Relay Module For Remote Monitoring Systems Having Alarm And Display Functionality

(71) Applicants: Joel D. Wiesner, St. Peters, MO (US); Kenneth M. Breitweiser, Brighton, MO (US); Robert B. Gaines, Lake Saint Louis, MO (US)

(72) Inventors: Joel D. Wiesner, St. Peters, MO (US); Kenneth M. Breitweiser, Brighton, MO (US); Robert B. Gaines, Lake Saint Louis, MO (US)

(73) Assignee: Tyco Healthcare Group LP, Mansfield, MA (US)

(21) Appl. No.: 13/334,463

(22) Filed: Dec. 22, 2011

(51) Int. Cl. G08B 1/08

(52) U.S. Cl. 340/539.1

(57) ABSTRACT

Wireless relay modules for enabling alarm recognition and alerts in networked communications between a series of medical devices and a remote monitoring device via wireless relay networks and/or internet-accessible wireless communications networks. The wireless relay module including a receiver, a first transmitter coupled to the wireless relay network, a second transmitter coupled to the internet-accessible wireless communication network, a controller and a display. The controller identifying if received medical device data from the medical device includes an alarm condition and causing the display to display an alert accordingly. The wireless relay module may additionally include a speaker alone or in combination with a microphone for providing an audible alert of the alarm condition and verbal communication between a local healthcare provider and a clinician at the remote monitoring device.

### RELATED APPLICATION

This application is related to U.S. patent application Ser. No. 13/006,769, filed Jan. 14, 2011, entitled “Wireless Relay Module for Remote Monitoring Systems”, which is assigned to the assignee of the present invention and incorporated herein by reference in its entirety for all purposes.

### FIELD OF THE INVENTION

The present application is directed to networked communications between a series of medical devices and remote monitoring devices via wireless relay networks and/or internet-accessible wireless communications networks having alarm monitoring and display abilities.

### BACKGROUND OF THE INVENTION

In critical care and home care health service centers including hospitals, clinics, assisted living centers and the like, caregiver-patient interaction time is at a premium. Caregivers are needed to respond rapidly to significant health conditions because any delay can be the difference between life and death. Systems of centralized monitoring have been developed to more efficiently utilize caregivers' time, by transmitting physiological data from each patient (or from graphically-dispersed critical care health service centers) to a centralized location.

At this centralized location, a single or small number of technicians monitor all of this patient information to determine patient status. Information indicating a patient alarm condition will cause the technicians and/or system to communicate with caregivers to provide immediate patient attention, for example via wireless pagers and/or cell phones, and/or by making a facility-wide audio page.

The information transmitted to the centralized location could be performed over a local area network, such as with a “WiFi” network based on IEEE 802.11 standards. The problem, however, with this network is that it is often difficult to secure sufficient local area network access for the purpose of providing centralized monitoring. Moreover, when a patient is located remotely from a critical care health service center (e.g., at home), access to traditional local area network facilities such as a WiFi network may be unavailable or not sufficiently reliable to support critical care monitoring applications.

An alternative is to use WiFi is ZIGBEE, based on the IEEE 802.15.4 standard for wireless personal area networks. The ZIGBEE networks have previously been used for collecting information from a variety of medical devices in accordance with IEEE 11073 Device Specializations for point-of-care medical device communication, include for example pulse oximeters, blood pressure monitors, pulse monitors, weight scales and glucose meters. See, e.g., ZIGBEE Wireless Sensor Applications for Health, Wellness and Fitness, the ZIGBEE Alliance, March 2009, which is incorporated by reference herein in its entirety for all purposes.

The advantages of ZIGBEE networks are that the network is dynamically configurable (e.g., “self-healing” mesh configurations) and operates with low power requirements (e.g., enabling ZIGBEE transceivers to be integrally coupled to the medical devices under battery power). However, transmission ranges between individual ZIGBEE transceivers are generally limited to no more than several hundred feet. As a consequence, ZIGBEE networks are generally unusable for centralized monitoring locations located off-site.

In addition, medical devices often include alarms which are important in alerting caregivers to possible patient harm. However, there are numerous situations in which the medical device alarm may be compromised and thus prevent a caregiver from being alerted. These situations include, for example, a device or alarm component malfunction, a closed door to a patient's room preventing the alarm sound from reaching a caregiver outside of the room, and/or the caregiver being located on a different floor (as often occurs, for example, in homecare situations). Along with alarm issues, there is also the problem of ensuring information about the alarms and/or medical devices is properly displayed to the caregiver to ensure the caregiver responds and acts appropriately in that response.

Therefore, it would be desirable to provide wireless relay modules to enable centralized monitoring of medical devices using wireless relay networks and/or internet-accessible wireless communications networks and having alarm monitoring and display capabilities.

### SUMMARY OF THE INVENTION

The present invention is directed to wireless relay modules for enabling alarm recognition and display alerts in networked communications between a series of medical devices and remote monitoring devices via wireless relay networks and/or internet-accessible wireless communications networks. The wireless relay module comprises a display, a receiver capable of wirelessly receiving medical device data over a wireless relay network from at least one medical device along with a first transmitter capable of wirelessly transmitting medical device data to a second wireless relay module over the wireless relay network, and a second transmitter capable of wirelessly transmitting data over an internet-accessible wireless communication network. It is possible for the transmitters and receivers to be implemented as transceivers.

A controller is coupled to the first and second transmitters, and controls the wireless relay module to select one of said first or second transmitter for transmitting medical device data received by the receiver over one of the two respective networks. The controller is further capable of determining that at least a portion of the received medical data is indicative of an alarm condition and causing the display to display an alert indicative of the alarm condition to alert caregivers.

The alert may include, for example, at least one of medical device description, medical device identification, medical device location, patient identification, patient condition, alarm type or code, alarm error code, and alarm severity or priority. The information indicative of an alarm condition in certain instances may be received from the wireless relay module itself and/or the second wireless relay module as well as possibly being received from the one or more medical devices as described above.

In another embodiment, the controller is configured to alternately display alerts on the display at intermittent intervals if data from more than one medical device data is indicative of alarm conditions. The controller may determine what information is displayed, as well as the duration of such information on the display based upon the severity of the alarm condition. In a further embodiment, the controller is configured to display a color on the display indicative of the alarm condition or normal, non-alarm status.

In yet a further embodiment, a speaker is coupled to the controller, where the speaker is capable of providing an audible alert, e.g., speech or other sounds, of the alarm condition. It is contemplated in accordance with the invention that the volume or type of such audible alert is indicative of a type or severity of the alarm condition. Moreover, alternative embodiment of the wireless relay module includes a microphone and speaker to facilitate voice communication between a caregiver proximate the wireless relay module and a clinician or technician at a remote monitoring device.

### BRIEF DESCRIPTION OF THE DRAWINGS

The invention will become more readily apparent from the Detailed Description of the Invention, which proceeds with reference to the drawings, in which:

FIG. 1 present a schematic diagram of an exemplary architecture for a system for monitoring medical devices according to the present invention;

FIG. 2 presents a schematic diagram further illustrating exemplary wireless network components of the architecture according to FIG. 1;

FIG. 3 presents a schematic diagram illustrating an exemplary wireless relay module associated with the architecture according to FIG. 1;

FIG. 4 presents a flow diagram illustrating a first exemplary method of operation for the architecture according to FIG. 1;

FIG. 5 presents a flow diagram illustrating an exemplary alarm and display process;

FIG. 6 presents a flow diagram illustrating a second exemplary method of operation for the architecture according to FIG. 1; and

FIG. 7 presents a schematic diagram illustrating a further exemplary embodiment of the wireless relay module of FIG. 3 with voice interaction capabilities.

### DETAILED DESCRIPTION OF THE INVENTION

Reference will now be made in detail to exemplary embodiments of the invention, including the best modes contemplated by the inventors for carrying out the invention. Examples of these exemplary embodiments are illustrated in the accompanying drawings. While the invention is described in conjunction with these embodiments, it will be understood that it is not intended to limit the invention to the described embodiments. Rather, the invention is also intended to cover alternatives, modifications, and equivalents as may be included within the spirit and scope of the invention as defined by the appended claims.

In the following description, specific details are set forth in order to provide a thorough understanding of the present invention. The present invention may be practiced without some or all of these specific details. In other instances, well-known aspects have not been described in detail in order not to unnecessarily obscure the present invention.

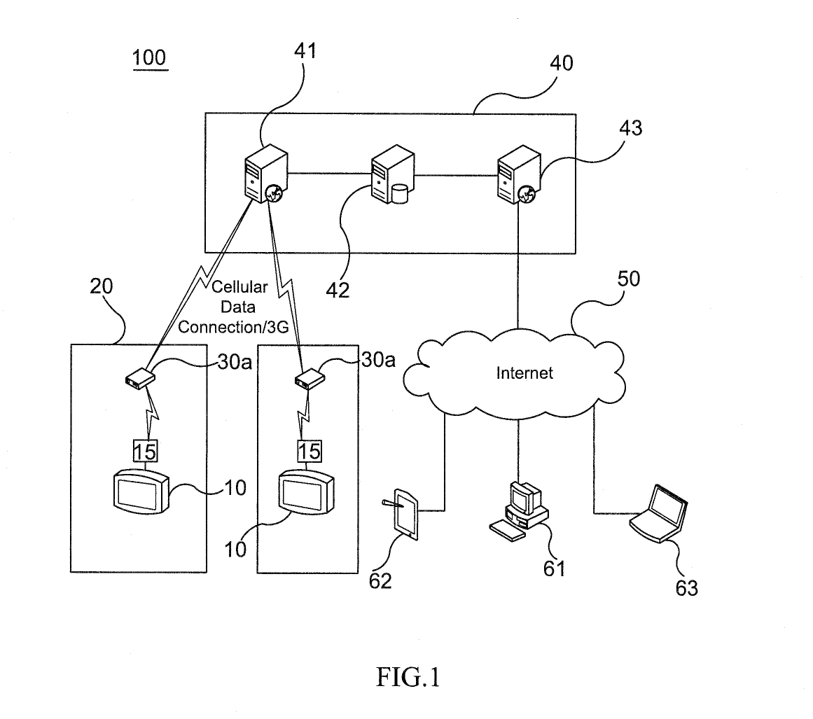

For the purpose of illustrating the present invention, exemplary embodiments are described with reference to FIGS. 1 through 7.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this invention belongs.

A schematic diagram of an exemplary architecture 100 for a system for monitoring medical devices in accordance with the present invention is illustrated in FIG. 1. One or more medical devices 10 are provided at a patient facility 20 for monitoring the medical condition and/or administering medical treatment to one or more patients. Patient facility 20 may comprise a critical care health service center (for example, including hospitals, clinics, assisted living centers and the like) servicing a number of patients, a home facility for servicing one or more patients, or a personal enclosure (for example, a backpack) that may be attached to or worn by an ambulatory patient. Associated with each medical device 10 is an interface circuit 15 that includes a transceiver for transmitting and receiving signals in a facility-oriented wireless network such as, for example, a Low-Rate Wireless Personal Area Network or “LR-WPAN,” ZIGBEE network or other low-power personal area networks such as the low power Bluetooth networks, e.g., Bluetooth 4.0, existing or presently under development or consideration. It should be understood that interface circuit 15 may be contained within or disposed external to medical device 10 in accordance with the present invention. Also provided within the patient facility 20 are one or more relay modules 30.

As illustrated in FIG. 1, a suitable access point 40 useable with the present invention may include an inbound web server 41 that incorporates or otherwise has access to a transceiver for communicating with the relay modules 30a over the WWAN. Medical device data received by the inbound web server 41 over the WWAN is forwarded to a secure data storage server 42, which is configured for example to log the received data in association with identification information of the associated medical devices. As used herein, “data” and “medical device data” means data from or about the medical device including, for example, medical device identification, software, settings or status information (including alarm information and/or severity) and/or patient identification, patient personal identification numbers “PINs”, patient prescriptions, patient medical and/or physiological data collected, produced and/or generated by the medical device.

An outbound web server 43 is configured, for example, to receive and qualify data retrieval requests submitted by one or more of remote monitoring devices 61, 62 and 63 over a broad-band network 50 (for example, over the Internet), to request associated medical device data to be retrieved from the secure data storage server 42, and to format and transmit the retrieved data to the one or more remote monitoring devices 61, 62 and 63 for display on associated device displays. While this disclosed architecture for the access point 40 is illustrated with an exemplary embodiment of the present invention, it should be understood that any architecture for the access point 40 that enables the receipt, storage and retrieval of medical device data on a device display of the one or more remote monitoring devices 61, 62 and 63 is intended to be included within the scope of the present invention.

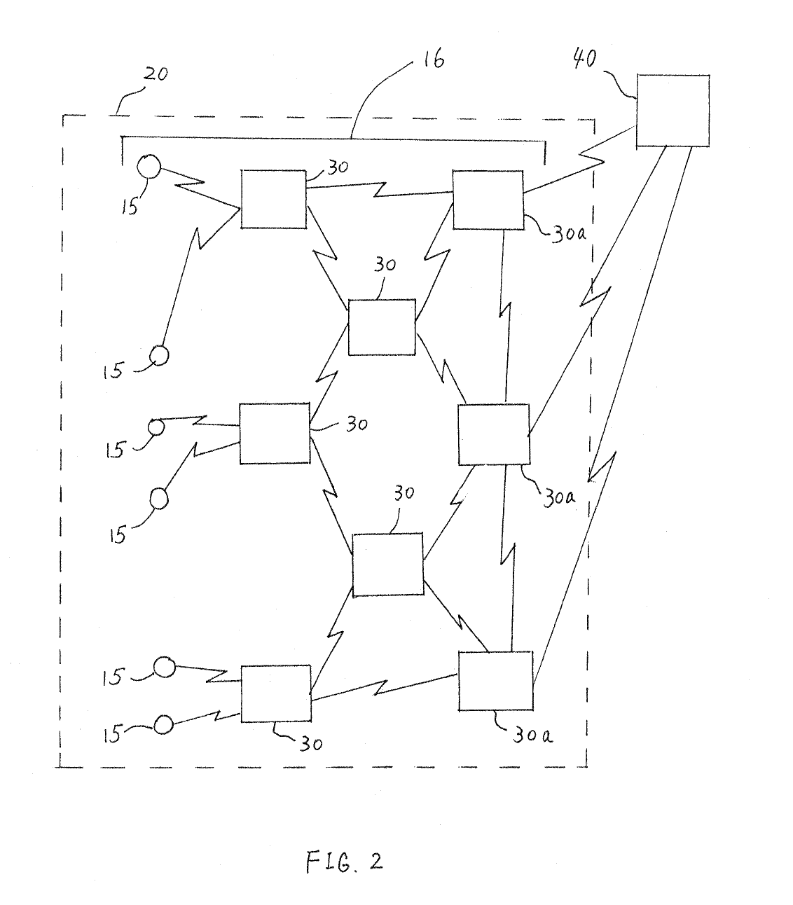

FIG. 2 presents a block diagram that further illustrates exemplary components of the inventive architecture that are located within or otherwise associated with the patient facility 20 of FIG. 1. In FIG. 2, a number of interface circuits 15 and relay modules 30, 30a are arranged in a mesh network 16 within the patient facility 20. The interface circuits 15 and relay modules 30, 30a are configured to communicate with one another via associated wireless links. In a preferred embodiment of the present invention represented in FIG. 2, the network 16 is a ZIGBEE mesh network based on IEEE 802.15.4. However, the network 16 may be organized according to a variety of other wireless local area network (WLAN) or WPAN formats including, for example, WiFi WLANs based on IEEE 802.11 and Bluetooth WPANs based on IEEE 802.15.1.

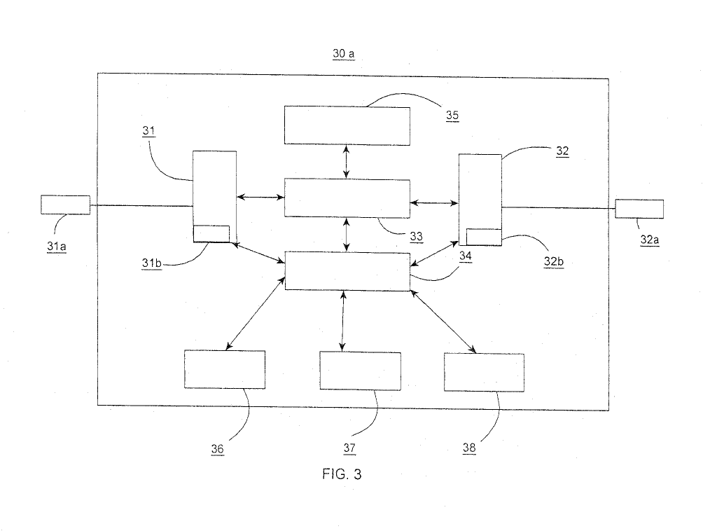

In FIG. 2, each relay module 30 includes a first transceiver for receiving signals from and transmitting signals to the interface circuits 15 in the facility-oriented wireless network discussed above. Relay modules 30a (as described in greater detail with regard to FIG. 3) correspond to relay modules 30, and further include a second transceiver for wirelessly transmitting signals to and receiving signals from an access point 40 via a wireless wide-area network or “WWAN”. Suitable WWANs for use with the present invention include, for example, networks based on a Global System for Mobile Communications (GSM) or Code Division Multiple Access (CDMA) cellular network or associated with the 2G, 3G, 3G Long Term Evolution, 4G, WiMAX cellular wireless standards of other International Telecommunication Union-Radiocommunication Sector (ITU-R). For compliance with Health Insurance Portability and Accountability Act of 1996 (HIPAA) regulations, communications over each of the facility-oriented wireless network and WWAN are preferably conducted securely using, for example, using a Secure Sockets Layer (SSL) protocol or a Transport Layer Security (TLS) protocol.

In the illustrated ZIGBEE mesh network 16 of FIG. 2, each of the interface circuits 15 includes a communications interface such as, for example, a wired communications interface, to an associated medical device 10. In addition, each of the relay modules 30, 30a includes at least one transceiver configured to communicate with other relay modules 30, 30a in the ZIGBEE mesh network 16. Relay modules 30a further include at least a second transceiver for communicating over the WWAN with the access point 40.

The representative ZIGBEE mesh network 16 provides the advantages of being self-configurable when one or more interface circuits 15 and/or relay modules 30, 30a are added to the network, and may be self-healing when one or more interface circuits 15 and/or relay modules 30, 30a are removed from or otherwise disabled in the network. Sub-groupings of the interface circuits 15 and relay modules 30, 30a may be provided in a defined geographic space (for example, on an individual floor or within a region of a floor in a multi-floor home or care facility).

FIG. 3 provides a block diagram illustrating exemplary components of relay module 30a. In FIG. 3, the relay module 30a includes a first transceiver 31 for wirelessly communicating with interface circuits 15 and other relay modules 30, 30a in the WLAN or WPAN 16 of FIG. 2 via an antenna 31a. A transceiver as contemplated in this description may include a receiver and/or transmitter. The relay module 30a further includes a second transceiver 32 for wirelessly communicating with the access point 40 over the WWAN via an antenna 32a. Each of the transceivers 31, 32 is in communication with a data processing circuit 33, which is configured to operate under the control of a controller, e.g., processor 34 to accept data received by the transceivers 31, 32 and store the received data in a buffer element 35.

In addition, the data processing circuit 33 is further configured to retrieve data from the buffer element 35 under the direction of the processor 34 and provide the retrieved data to a selected one of the transceiver 31 or transceiver 32 for transmission. In order to make a selection, the processor 34 is configured to communicate with respective status modules 31b, 32b of the transceivers 31, 32 in order to determine a communications status of each of the transceivers 31, 32.

The processor 34 may be a single dedicated processor, a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In accordance with the present invention, the medical device data received by one of the transceivers 31, 32 from the one or more medical devices 10 may include, for example, information indicative of an alarm condition. In addition to the types of data previously provided herein, exemplary received information may include, for example, at least one of medical device description, medical device identification (e.g., unique device number), medical device location (e.g., device/patient room number), patient identification (e.g., patient identification number), alarm type, alarm error code, and/or alarm severity. Exemplary methods in which an alarm condition may be determined include predetermined codes, look-up table(s) and or algorithms for identifying alarm conditions based on processing the received information, as well as those described for emergency codes in co-filed U.S. patent application Ser. No. ______ and entitled, “Wireless Relay Module Having Emergency Call Functionality,” which is assigned to the assignee of the present invention and incorporated by reference herein for all purposes.

In addition to information indicative of an alarm condition contained in the medical device data received from one or more medical devices 10, it is also possible to receive such information from another relay module and/or internally generated in the relay module 30a itself. For example, the relay module 30a could receive such information from another relay module when the other relay module malfunctions. In this way, it is assured that the relay module 30a provides the necessary redundancy for another relay module. Additionally, it is further possible for such information to be transmitted to the relay module 30a from the other relay module when the information is indicative of a high severity alarm condition, e.g., a significant medical emergency, such as emergency 911. Such redundancy will enable a sufficient number of caregivers to be notified of the emergency condition through multiple relay modules to facilitate a prompt response.

In another exemplary implementation, the relay module 30a may be notified if another relay module is experiencing numerous alert conditions associated with other modules or medical devices to effectively communicate the alarm information to caregivers. If this occurs, the other relay module may, for example, divert the information indicative of an alarm to the relay module 30a using the WLAN or WPAN 16. The particular relay module 30a selected to receive the alarm information from the other relay module may be based on many factors such as, for example, relay module location, relay module availability, number of caregivers at a given location and/or floor, etc.

In another embodiment, it is possible that the information indicative of an alarm condition to be received at the relay module 30a, but for some reason, such as a malfunction and/or data transmission bottleneck, the alarm is never communicated audibly and/or visually to the caregivers. To prevent this occurrence it is possible for the relay module 30a to transmit a message back to the one or more medical devices 10 indicating that an alarm was presented to the caregiver. If the message is not received within a predetermined amount of time by the one or more medical devices 10, then one or more medical devices 10 may attempt to communicate its medical device data to other relay modules to ensure the alarm is addressed. Similar factors, e.g., location, availability, number of caregivers, etc., as described above useable for selecting the relay module(s) for providing alerts for the one or more medical devices.

In a further embodiment, the relay module 30a may internally generate its own alarm and/or device signals in relation to the relay module 30a, for example, the current status of the relay module 30a (e.g., A/C power loss) and/or current communication or connection status (e.g., status with the WLAN or WPAN 16 or WWAN).

After identifying that received data is indicative of an alarm condition, the processor 34 may transmit a message containing alarm information including, for example, at least one of medical device description, medical device identification, medical device location, patient identification, alarm type, alarm error code, and/or alarm severity, to a display 36 attached to the relay module 30a. In this way, an alarm alert may mirror an alarm alert emitted by the originating medical device. The particular type of display chosen for use with the relay module 30a is not critical for practicing the present invention. Accordingly, it is possible for display 36 to be a monochrome or color dot matrix, LCD, LED or other display device.

In addition, the processor 34 may also employ a speaker 37, such as a loudspeaker, coupled to the relay module 30a to emit an audible alert indicative of the alarm condition. It is possible for the audible alert based on the alarm condition to be at least one of volume, pitch, tone, type, audible sequence or duty cycle, or recorded sound to indicate the type, urgency or severity of the alarm condition. It is advantageous for an alarm indicating a life-threatening emergency to be more attention-getting, e.g., loud siren, than alarms for less significant conditions that may be addressed by, for example, beeps or calmer tones.

It is also possible for the emitted audible alerts to be spoken words, commands, tones or other sounds. In this way, if the alert emitted from the one or more medical devices 10 is not directly addressed, then the relay module 30a alarm sounds should alert any caregivers located outside of the patient's room. The processor 34 may also in accordance with the invention cause a signal to be transmitted by, for example, the first transceiver 31 over the WLAN or WPAN 16 to one or more devices including, for example, PDAs, cell phones, pagers, and tablets. In addition, the alarm information may be transmitted over the WWAN using the second transceiver 32 to the one or more devices.

In addition, an input/output circuit 38 may be electrically connected to, for example, user-actuatable buttons, dials or input mechanisms associated with the relay module 30a. Using these buttons, dials, or input mechanisms, the audible alerts produced by the relay module 30a may be muted, i.e., disabled, or volumes substantially reduced. The muting or volume reduction may alternatively be in response to the relay module 30a receiving a signal from the originating medical device transmitting the information, such as in response to a caregiver acknowledging that the emergency condition is being addressed by entering the proper inputs to the originating medical device. Even with the audible alerts muted or otherwise disabled, it is recommended to continue displaying the alerts on the display 36. The display 36 may continue to display alerts until likewise the alert condition is extinguished or confirmation from a caregiver at the originating medical device or the relay module 30a is received.

In accordance with another aspect of the invention, the processor 34 may control the display 36 to alternate or cycle displayed information intermittently with information from a single medical device or multiple medical devices. For instance, the processor 34 may cause an visual alarm alert indicating an alarm condition (based upon a portion of medical device data) from a first medical device may be shown on the display 36, for example, for a time period of between 2 to 30 seconds before displaying information for another medical device. The visual alarm alerts corresponding to higher severity alarm conditions may be shown for longer durations then alerts of for lower severity alarm conditions. Also, the type of alarm condition may further dictate the display length of time for visual alarm alerts or other information from a particular medical device. Additionally, the display 36 may also or alternatively display the number of medical devices communicating information indicative of alarm conditions to the relay module 30a and/or show a description of such devices.

In addition, it is possible for the display 36 to display the alerts in different foreground or backlight colors, such as green backlight for normal operation or red backlight for alarm situations, to use color representing the respective severities of alarm conditions. It is further possible for the colors to correspond to specific alarm conditions (e.g., low glucose level) and/or general groups of conditions (e.g., heart conditions). The display may alternatively or in addition incorporate, for example, a multi-colored light-emitting diode array to display the status of the medical devices.

The display 36 may also be used to display non-alarm related information including, for example, battery charge level or status, software version, software download status, relay module network status, handshake status and signal strength of the received WLAN or WPAN 16, and/or WWAN signals. Displayed information for the strength of respective monitored signals and other may be displayed alone or in a combination with the alerts. The signal strength information could be depicted by, for example, by sequential display segments such as, for example, more than one series of different sized light-emitting diodes (LEDs) that would advantageously enable simultaneous display of at least two different network signal strengths for viewing by the caregiver.

As with the display of externally generated information indicative of alarm conditions, it is possible for alerts for internally generated information indicative of an alarm condition by the relay module 30a to also be displayed by display 36. For example, alerts representative of information during start-up or current status of the relay module 30a and/or current communication or connection status with the WLAN or WPAN 16 and WWAN may be shown on the display elements 36. In another embodiment, the processor 34 may cause the display 36 to include information associated with the charge level of a battery (not shown) contained within the relay module 30a, whether by remaining minutes and/or hours of life or other graphical depictions.

Relay module 30a may preferably be provided as a small physical enclosure (not shown) with an integral power plug and power supply circuit, such that the relay module 30a may be directly plugged into and supported by a conventional wall outlet providing commercial A/C power. Relay module 30a may also preferably include a battery back-up circuit (not shown) to provide uninterrupted power in the event of A/C power outage as well as for ambulatory use of the relay module. Alternatively, relay module 30a may be provided with rechargeable and/or replaceable battery power as a primary power source for ambulatory use. Further, it is possible that the relay module 30a could be recharged while, for example, plugged into a car's cigarette receptacle. While this recharging is occurring, the transceivers could be disabled to ensure battery life is preserved.

Devices 36-38 are shown as separate and distinct devices in FIG. 3 for illustration purposes only and one skilled in the art should readily understand that the functionality of devices 36-38 may be combined into a single or larger or smaller number of devices than that shown in FIG. 3.

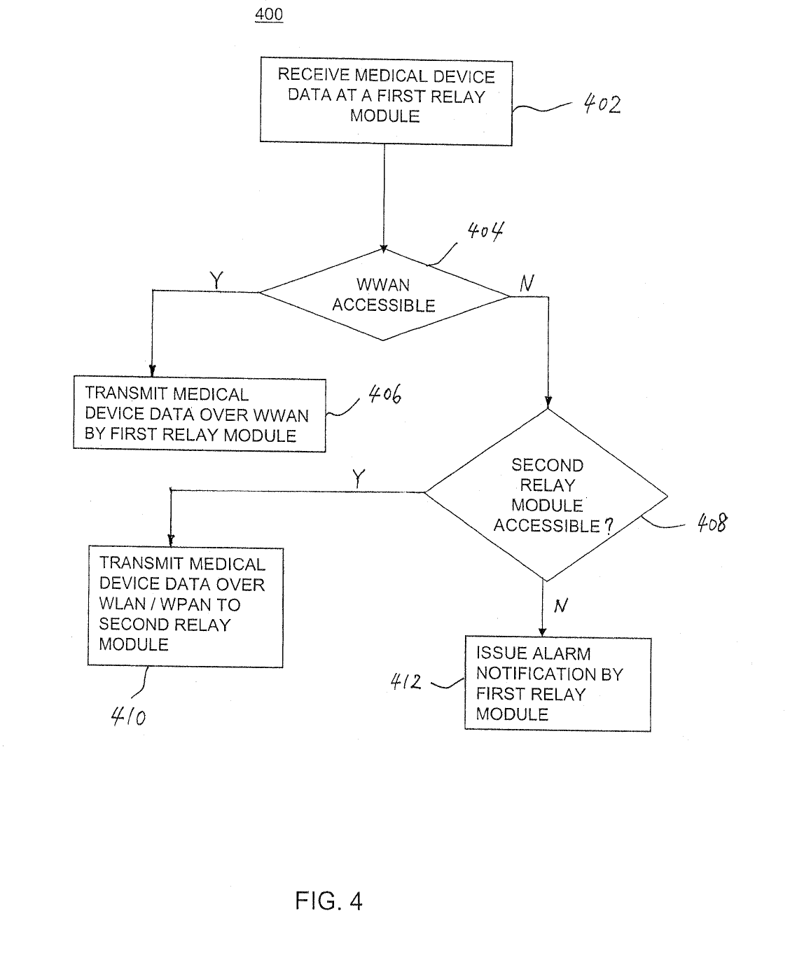

FIG. 4 presents a flow diagram 400 illustrating an exemplary method of operation for the architecture according to FIG. 1 and relay module 30, 30a components of FIGS. 2 and 3 relating to the transmission of medical device data obtained from a medical device 10 to the access point 40. At step 402 of the method 400, the medical device data is received at a first one of the relay modules 30a from one of the interface circuits 15 and/or other relay modules 30, 30a over the ZIGBEE mesh network 16. At step 404, the processor 34 of the one relay module 30a determines whether the WWAN is accessible by that relay module 30a.

The determination of step 404 may be carried out in a variety of manners. For example, the processor 34 may interrogate the status module 32b of the transceiver 32 at the time of the receipt of the medical device data to determine a status of access for the transceiver 32 to the WWAN (for example, as the result of the transceiver 32 detecting an access signal of the WWAN having adequate signal strength). Alternatively, the processor 34 may interrogate the status module 32b at a different time including, for example, at system start-up and/or periodically (for example, hourly), and maintain a status indicator such as in the buffer 35 or another storage element to be retrieved at the time of receipt of the medical data. As yet another alternative, the relay module 30, 30a may be assigned a predetermined, fixed role within the network 16. For example, relay modules 30a in the network 16 may be assigned a data routing assignments by a controller or “master” relay module. By definition, the WWAN status for relay module 30 that does not possess WWAN access capability shall have a fixed status of “WWAN inaccessible.”

If, as provided for in step 404, the status module 32b indicates that the WWAN is accessible by the transceiver 32, then the processor 34 will proceed to step 406 to instruct the data processing circuit 33 of the one relay module 30 to retrieve the medical device data from the buffer 35 (as necessary) and forward the medical device data to the transceiver 32 for transmission to the access point 40 over the WWAN.

Alternatively, in step 404, the status module 32b may indicate that the WWAN is not accessible by the transceiver 32. For example, if the one relay module 30a is located on a basement floor of the building in an area that is substantially shielded with respect to WWAN signals, the WWAN may not be accessible to the one relay module 30a. In this event, at step 408, the processor 34 determines whether a second relay module 30a is accessible via the WLAN or WPAN 16. Again, this determination may be made in a variety of manners including by instructing the transceiver 31 to send a handshake signal transmission directed to a second relay module 30a and to listen for a reply, or by retrieving a stored status indicator for the second relay module 30a.

If the second relay module 30a is accessible, then the processor 34 instructs the data processing circuit 33 of the one relay module 30a to retrieve the medical device data from the buffer 35 (as necessary) and forward the medical device data to the transceiver 31 for transmission to the second relay module 30a over the WLAN or WPAN 16 at step 410. Alternatively, if the second relay module 30a is inaccessible in step 408, this portion of the process 400 may preferably be repeated to search for a further relay module 30a that is accessible. In the event that no other relay module 30a is available, the processor 34 of the one relay module 30a may preferably issue an alarm notification at step 412. Such an alarm notification may, for example, include one or more of local visual and audio alerts as directed by processor 34 via the display 36 or speaker 37, alarm messages directed by the processor 34 to another accessible WLAN or WPAN 16, or WWAN via one or more of the transceivers 31, 32, and/or alarm messages generated by the inbound web server 41 of the access point 40 of FIG. 1 after a specified time period has been exceeded during which a handshake signal of the relay module 30a is due to be received at the inbound web server 41.

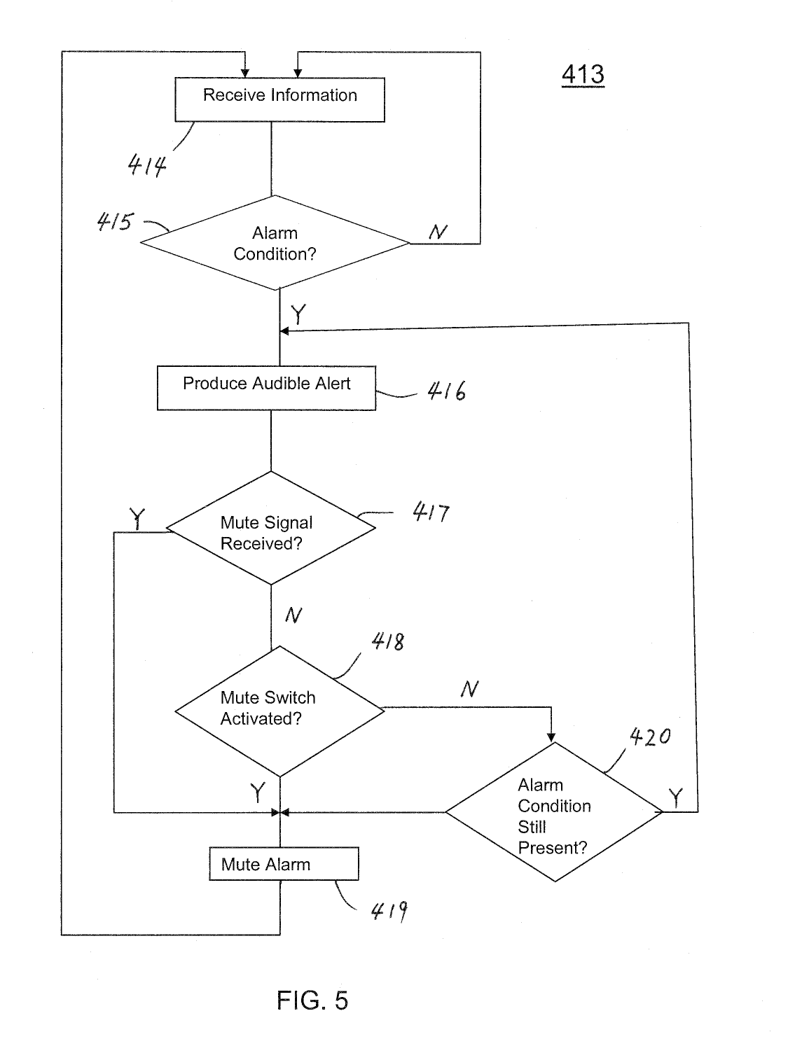

FIG. 5 depicts a flow diagram 413 representing an exemplary alarm alert and display process. In accordance with the flow diagram 413, at step 414 the processor 34 of the relay module 30a of FIG. 3 receives information such as medical device data from a medical device, other rely module or internally generated by the relay module. Then, the method 413, in step 415, determines whether the information obtained in step 414 is indicative of an alarm condition or an alarm condition is otherwise present. If no alarm condition is detected at step 415, then method 413 reverts back to step 414. If, in step 415, an alarm condition is detected based on the obtained information by step 414, the method 413 proceeds to step 416.

In step 416, the processor 34 produces an alarm alert by transmitting signals representing an alert to be displayed to the display 36 and/or transmits signals representing speech or other audible information (for an audible alarm) to the speaker 37 of FIG. 3. Then, the method 413 proceeds to step 417. In step 417, it is determined whether the module 30a receives medical device data or other information instructing the module to mute or disable the audible alarm or an input signal is otherwise received requesting to mute the sound or disable the audible alarm. If such input signal is received then, in step 419, the processor 34 mutes the speaker 37, i.e., disable the audible alarm. However, in step 417, if no such input signal is received then the method 413 proceeds to step 418.

In step 418, the processor 34 determines whether a user-actuatable switch associated with the input/output circuit 38, e.g., a mute switch of the relay module 30a, has been activated. If such a switch has been activated then the method 413 proceeds to step 419 and the speaker 37 is muted to disable the emitted audible alarm. After the speaker is muted, the method 413 returns to step 414 and starts the process again. However, if in step 418, it is determined that the mute switch has not been activated then the method 413 proceeds to step 420 where the processor again determines whether the alarm condition is still present based upon, for example, newly received medical device data. If the alarm condition is no longer present, the method 413 proceeds to step 419 and the audible alarm is disabled. However, if in step 420 the alarm condition is still present then the method 413 reverts back to step 416 and the audible alert is produced, i.e., continued.

In an alternative embodiment, if in step 420 the alarm condition is present for a particular period of time (either fixed in duration or based upon the particular alarm condition), then in step 416 the emitted audible alarm may advantageously be changed or upgraded in decibel level, pitch, type of sound, duty cycle or speech command to draw greater attention and response to the alarm condition by potential responders. In addition to, or in the alternative to, this change in emitted audible alarm in response to the determination in step 420 that the alarm condition is present for a particular period of time then the relay module may transmit a signal to other nearby or remote relay module(s) to alert other potential responders of the alarm condition.

It should be understood that the method of 413 may operate with information received from plurality of medical devices or other wireless relay modules, and may provide the intermittent displaying of respective alarm alerts for particular time intervals or employ different foreground or background colors based upon the type or severity of the alarm condition.

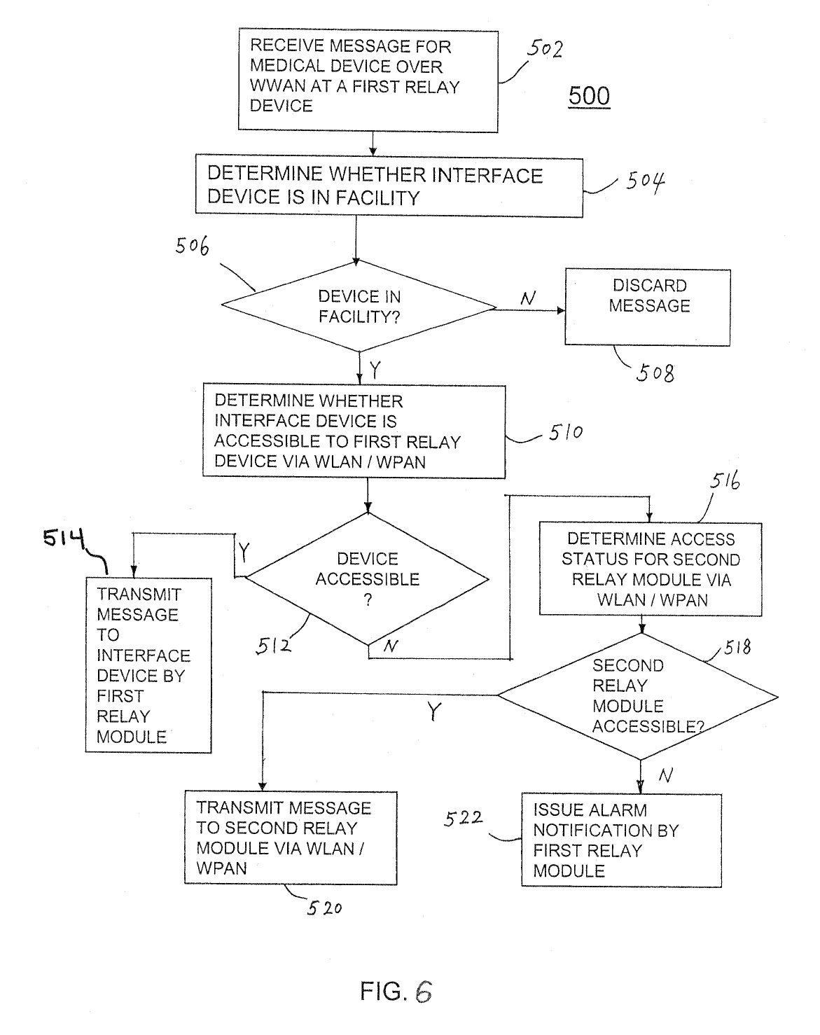

FIG. 6 presents a flow diagram illustrating another exemplary method of operation 500 for the architecture according to FIG. 1, relating to the transmission of a message from the access point 40 to be received by one of the medical devices 10. This enables the access point 40, for example, to communicate with medical devices in order to download new firmware or software, to respond to error messages initiated by the medical devices (for example, to re-set a device or remove it from service, or to run device diagnostics), and to operate the medical device (for example, to adjust a flow rate on a feeding pump).

At step 502 of the method 500, the message is received at the first one of the relay modules 30a from the access point 40 via the WWAN. At step 504, the one relay module 30 determines whether the message is intended to reach one of the interface circuits 15 and/or other relay modules 30, 30a located in the facility 20. This may be accomplished, for example, by maintaining a list of active devices 15 and modules 30, 30a in the buffer 35 or in a manner otherwise accessible to the one relay module 30a, or coding an identifier of the interface circuit 15 or module 30, 30a to include an identity of the facility 20 that is stored in the buffer 35 or is otherwise identifiable to the one relay module 30. In the alternative, the received message may include a device identifier such as a serial number or an assigned identifier. Such a received message would then be broadcasted to all or a subset of interface circuits 15 in the facility and each interface circuit 15 determines if it was the intended recipient or should otherwise act upon or ignore the message.

If the one relay module 30a determines at step 506 that the interface circuit 15 or module 30, 30a is not located in the facility, the one relay module 30 may preferably proceed to discard the message at step 508, and/or alternatively alert the access point 40 with a non-delivery message. If the interface circuit 15 is located in the facility 20, the one relay modular 30 determines at step 510 whether the interface circuit 15 or relay module 30, 30a accessible to the one relay device 30 via the WLAN or WPAN (for example, by consulting a list stored in the buffer 35 or that is otherwise accessible to the one relay module 30, or by instructing the transceiver 31 to send a handshake or test transmission directed to the interface circuit 15 and to listen for a reply).

If the one relay module 30a determines at step 512 that the device 15 or relay module 30, 30a is accessible, then at step 514, it transmits the message via network 16 to that device or relay module via the transceiver 31. If the one relay module 30a alternatively determines at step 512 that the device or relay module is not accessible, it proceeds at step 516 to determine whether a second relay module 30, 30a is accessible via the WLAN or WPAN (for example, by instructing the transceiver 31 to send a handshake or test transmission directed to the second relay module and to listen for a reply). If the second relay module 30, 30a is available, then the one relay module 30 forwards the message to the transceiver 31 for transmission to the second relay module 30, 30a over the WLAN or WPAN. If the second relay module 30, 30a is inaccessible, then this portion of the process 500 may preferably be repeated to search for a third relay module 30, 30a that is accessible. Alternatively, or in the event that no other relay module 30, 30a is available, the one relay module 30 may preferably issue an alarm notification at step 522, preferably in one of the same manners described above in reference to the method 400 of FIG. 4.

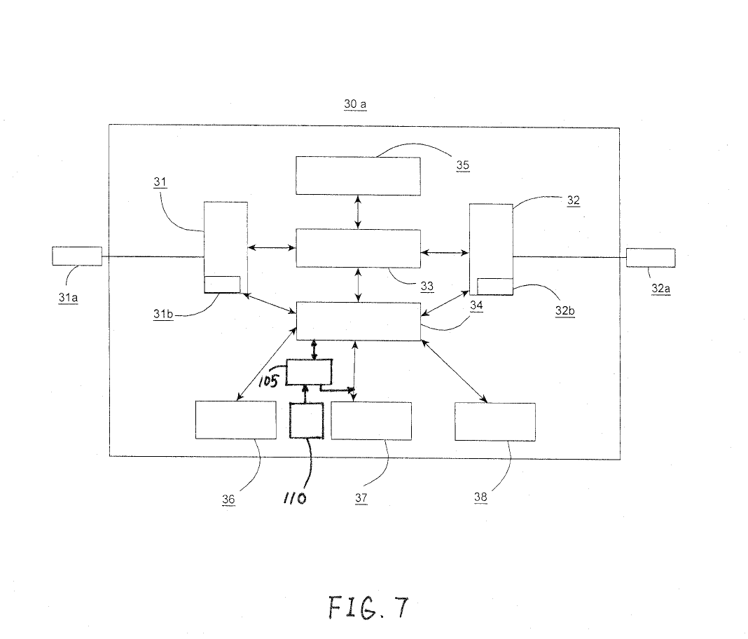

FIG. 7 depicts a block diagram of an exemplary alternative embodiment of the relay module 30a of FIG. 3 that enables voice communication and interaction between a caregiver proximate the relay module 30a and a clinician or technician at the remote monitoring device. The identical components in the FIGS. 3 and 7 are like numbered including, for example, the first and second transceivers 31 and 32, data processing circuit 33, processor 34 and data buffer 35. The relay module 30a of FIG. 7 further includes a speech codec 105 connected to a microphone 110 and the speaker 37.

The particular speech codec selected for the codec 105 is not critical to the present invention as long as it is compatible and/or interoperable with the speech codec of the corresponding remote monitoring device. Suitable codecs for the speech codec 105 include, for example, fixed rate codecs such as voice-over-internet-protocol (VoIP) codecs in compliance with the ITU standard H.323 that provides speech coding in accordance with VoIP are ITU standards G.711 (PCM), G.723.1 (MP-MLQ & ACELP), G.729 (CSACELP), GSM-FR; or Adaptible Multi-Rate (AMR) standards such the European Telecommunication Standard Institute (ETSI) and Third Generation Partnership Project (3GPP) IMT-2000. Alternatively, it is possible to employ codecs useable for transmitting encoded speech signals over a mobile telephone network.

The configuration of the relay module 30a of FIG. 7 enables a caregiver proximate the relay module 30a to engage in a conversation with a clinician or technician proximate the remote monitoring device using, for example, a VoIP or VoIP-like exchange of encoded speech signals. Specifically, in operation of the relay module 30a of FIG. 7, speech uttered by a caregiver proximate the relay module 30a is converted by microphone 110 to analog speech signals that are digitized and encoded by the codec 105. The processor 34 then transmits the corresponding digitized and encoded speech signals produced by the codec 105 directly over the wireless internet-accessible network alone or in combination with the wireless relay module network to the remote monitoring device. The remote monitoring device then decodes the digitized and encoded speech signals and converts such decoded signals into analog signals supplied to a speaker to generate the speech sounds be heard by the clinician or technician.

Conversely, digitized and encoded speech signals representing speech of the clinician or technician transmitted by the remote monitoring device are received by the module 30a wherein the processor 34 supplies such signals to the codec 105 which decodes the signals and converts the decoded signals to analog signals that are supplied to the speaker 37.

Although the implementation of the codec 105 and microphone 110 has been described with regard to exchanging VoIP signals, it should be readily understood that any method of exchanging speech signals may be employed for carrying out the invention including, for example, utilizing a cellular or mobile telephone codec or modem for codec 105 to transmit and receive speech signals, e.g., CDMA- or GSM-compliant speech signals over a mobile telephone network. Further, it is possible according to the invention for the codec 105 to be implemented as hardware and/or software in a single chip, chip set or as part of the processor 34.

In an alternative embodiment, it is possible to implement speech detection and/or recognition functionality into the codec 105 or processor 34 to enable the relay module 30a to identify specific command words to initiate the carrying out of a corresponding responsive action. For example, such speech recognition functionality may be triggered by processing signals supplied by the microphone 110 to identify terms “Help”, “Emergency” or “Call 911.” Upon detecting such trigger terms, the processor 34 to initiate the process of dialing an emergency response service such as “911,” with or without using synthesized or recorded speech to request confirmation from the caregiver to place such a call and initiate communication between the caregiver and the emergency response service. The dialing may be performed by hardware or software implemented in the processor 34, codec 105 or other components coupled to the processor 34. The speech recognition functionality may alternatively or additionally transmit a text message or other text or audio-visual correspondence to the emergency response service based upon identified spoken works or commands by the caregiver.

It should be readily understood that the relay module 30a of FIG. 7 is shown with the codec 105 and microphone 110 in combination with the display 37 for illustration purposes only. It is possible in accordance with the invention to implement a relay module with the codec with out a display or a relay module with a display and not a codec (as depicted in FIG. 3).

The architecture disclosed herein for providing networked communications between a series of medical devices and a remote monitoring device provides a number of distinct advantages in comparison to other monitoring systems. By employing ZIGBEE networks based on the IEEE 802.15.4 standard according to a preferred embodiment for wireless communications between the medical devices 10 and relay modules 30, 30a, power and size requirements can be minimized so that the interface circuits 15 can be easily and inexpensively applied to and/or integrated with the medical devices 10.

By introducing relay modules 30a that are part of the ZIGBEE network and are directly able to access off-site monitoring devices via a WWAN, access to and reliance on existing and potentially unreliable LAN facilities at a facility can be avoided. By incorporating relay features into the relay modules 30a that relay communications from a first relay module 30a to a second relay module 30a in the event that WWAN access to the first relay module 30a has been compromised, the present invention improves reliability and enables the use of conventional, low-cost cellular transceivers in the relay modules 30a for accessing the WWAN.

By limiting the configuration of cellular transceivers to just the relay modules 30a, costs can be further reduced. In addition, providing the relay modules 30a in a compact enclosure facilitates the relay modules 30a to be easily connected to reliable commercial power sources and easily moved when needed to reconfigure the ZIGBEE networks according to facilities changes.

It should of course be understood that while the present invention has been described with respect to disclosed embodiments, numerous variations are possible without departing from the spirit and scope of the present invention as defined in the claims. For example, the present invention may be based on any of a number of current and future WPAN, WLAN and WWAN standards beyond those explicitly described herein. It should also be understood that it is possible to use exclusively relay modules 30 in the WLAN or WPAN network 16 of FIGS. 1 and 2, with transceivers for communicating with other relay modules as well as over the WWAN.

In addition, respective interface circuits useable with the present invention may include components of and perform the functions of the module 30 to provide greater flexibility in accordance with the present invention. Further, numerous configurations of components for relay module 30 are useable with the present invention beyond the components shown in FIG. 3. For instance, an input-output buffer may be used with respective switches under control of a processor for directing medical device data to transceivers 31, 32 as needed. Moreover, it is intended that the scope of the present invention include all other foreseeable equivalents to the elements and structures as described herein and with reference to the drawing figures. Accordingly, the invention is to be limited only by the scope of the claims and their equivalents.

We claim:

1. A wireless relay module comprising:
a receiver capable of wirelessly receiving medical device data over a wireless relay network from at least one medical device;
a first transmitter capable of wirelessly transmitting the medical device data to a second wireless relay module over the wireless relay network;
a second transmitter capable of wirelessly transmitting the medical device data over an internet-accessible wireless communication network;
a display capable of displaying at least one of graphical data and text data;
a controller coupled to the first and second transmitters, the controller capable of controlling the wireless relay module to select one of said first or second transmitter for transmitting medical device data received by the receiver, the controller capable of determining that at least a portion of the received medical data is indicative of an alarm condition, and the controller causing the display to display an alert indicative of the alarm condition.

2. The wireless relay module of claim 1, wherein the alarm condition includes at least one of medical device description, medical device identification, medical device location, patient identification, alarm type, alarm error code, and alarm severity.

3. The wireless relay module of claim 1, wherein the receiver is configured to receive another alarm from a second wireless relay module.

4. The wireless relay module of claim 1, wherein the controller is configured to enable the display to alternatively show a plurality of alerts on the display at intermittent intervals.

5. The wireless relay module of claim 4, wherein the alternately displayed alarm alerts is based on receiving a signal from the second relay module.

6. The wireless relay module of claim 4, wherein the duration of respective intermittent intervals is determined by an alarm severity of the alerts to be displayed.

7. The wireless relay module of claim 1, wherein the controller is configured to show a color on the display depending on the alarm alert.

8. The wireless relay module of claim 7, wherein said color is a backlight color.

9. The wireless relay module of claim 1, wherein the controller is configured to enable the display to show a battery charge level of the wireless relay module.

10. The wireless relay module of claim 1 further comprising a second receiver coupled to the controller, said second receiver capable of wirelessly receiving data over the internet-accessible wireless communication network.

11. The wireless relay module of claim 1, wherein the controller is configured to cause the display to display strength of at least one of a received signal of the wireless relay network or internet-accessible wireless communication network.

12. The wireless relay module of claim 11, wherein the display is one or more light-emitting diodes of different sizes.

13. The wireless relay module of claim 1, wherein the display is a multi-colored light-emitting diode array to display the status of at least one medical device.

14. The wireless relay module of claim 1 further comprising a speaker coupled to the controller.

15. The wireless relay module of claim 14, wherein said controller is capable of causing said speaker to emit an audible alert having a characteristic indicative of a severity of the alarm condition.

16. The wireless relay module of claim 14, wherein said audible alert having a characteristic indicative of a severity of the alarm condition is at least one of volume, pitch, tone, type, audible sequence or duty cycle, or recorded sound.

17. The wireless relay module of claim 14 further comprising a user-actuatable input interface operatively coupled to the controller, the input interface configured to disable the audible alert.

18. The wireless relay module of claim 1 further comprising one or more devices coupled to the wireless relay module, the wireless relay module transmitting the alarm to the one or more devices.

19. The wireless relay module of claim 1 further comprising a speaker and a microphone coupled to the controller.

20. The wireless relay module of claim 19 further comprising a codec coupled between the controller and at least one of the speaker and microphone.

21. The wireless relay module of claim 20, wherein said codec provides speech detection and/or recognition functionality.

22. The wireless relay module of claim 20, wherein said controller is capable of providing codec functionality.

23. The wireless relay module of claim 22, wherein said controller is capable of providing speech detection and/or recognition functionality.

24. A computerized method comprising the steps of:
receiving data at a wireless relay module wirelessly transmitted from at least one medical device;
a. receiving data from the at least one medical device over a wireless relay network;
b. determining the status of an internet-accessible wireless communications network in communication with a first transmitter of said relay module;
c. transmitting said data from the at least one medical device over said communications network by said first transmitter if said determined status satisfies a particular criteria; and
d. transmitting said received data from said at least one medical device by a second transmitter in communication with the wireless relay network to a second relay module over the wireless relay network if said determined status fails to satisfy the particular criteria.
e. determining at the wireless relay module that at least a portion of the received data is indicative of an alarm condition; and
f. performing at least one of emitting an audible alarm at the wireless relay module based on the alarm condition, and displaying a visual alarm based on the alarm condition.

25. The method of claim 24, wherein the alarm condition includes at least one of medical device description, medical device identification, medical device location, patient identification, alarm type, alarm error code, and alarm severity.

26. The method of claim 24 further comprising receiving another alarm condition from the medical device or a second wireless relay module.

27. The method of claim 24 further comprising alternatively displaying information on the display at respective intermittent intervals if data from more than one medical device is indicative of a plurality of alarm conditions.

28. The method of claim 27, wherein the alternatively displaying information on the display at respective intermittent intervals is based on receiving a signal from another relay module.

29. The method of claim 28, wherein the duration of respective intermittent intervals is determined by an alarm condition severity of the alerts to be displayed

30. The method of claim 24, wherein the displayed visual; alarm has an associated predetermined color representing the severity of the alarm condition.

31. The method of claim 30, wherein said color is a backlight color.

32. The method of claim 30, wherein said color displayed information is display at least with a plurality of multi-colored light-emitting diodes.

33. The method of claim 24 further comprising displaying on the display an indication of a charge level of a battery connected to the wireless relay module.

34. The method of claim 24 further comprising displaying on the display at least one indication of signal strength of the at least one of the wireless relay network or internet-accessible wireless communication network.

35. The method of claim 24, wherein the step of emitting the audible alarm comprises emitting the audible alarm a characteristic based upon a severity of said alarm condition.

36. The method of claim 35 further comprising changing the emitted audible alarm by at least one of decibel level, type of sound, duty cycle or speech command if no response is detected to said audible alarm in a particular time interval.

37. The method of claim 24 further comprising the step of disabling the emitted audible alarm when a signal is received from a user-actuatable input.

38. The method of claim 24, further comprising the step of enabling voice communication between the relay module and a remote monitoring device.

39. The method of claim 24 further comprising the steps of:
receiving a voice command by the relay module; and
said relay module performing a function in response to said voice command.

40. The method of claim 39 wherein said function is dialing an emergency response service and establishing voice communication with said emergency response service.

41. A wireless relay module comprising:
a receiver capable of wirelessly receiving medical device data over a wireless relay network from at least one medical device;
a first transmitter capable of wirelessly transmitting the medical device data to a second wireless relay module over the wireless relay network;
a second transmitter capable of wirelessly transmitting the medical device data over an internet-accessible wireless communication network;
a microphone and speaker; and
a controller coupled to the first and second transmitters, microphone and speaker, the controller capable of controlling the wireless relay module to select one of said first or second transmitter for transmitting the medical device data received by the receiver, the controller also capable of exchanging voice information between a clinician proximate said module and a remote location via the internet-accessible wireless communication network.

42. The wireless relay module of claim 41 further comprising a codec coupled between the controller and at least one of the speaker and microphone.

43. The wireless relay module of claim 42, wherein said codec is voice-activated.

44. The wireless relay module of claim 42 wherein said processor provides voice-activated functionality.

45. The wireless relay module of claim 41 further comprising a display coupled to the controller.

46. The wireless relay module of claim 41 further comprising a dialer for establishing a telephone connection for the wireless relay module.

47. The wireless relay module of claim 40 further comprising a second receiver coupled to the controller, said second receiver capable of wirelessly receiving data over the internet-accessible wireless communication network.
